(19) United States
(12) Patent Application Publication
(10) Pub. No.: US 2009/0138444 A1
(43) Pub. Date: May 28, 2009

(54) METHOD OF SEARCHING METADATA SERVERS

(75) Inventors: Chul Su KIM, Daejeon (KR); Yong Joon LEE, Daejeon (KR); Jong-Hyun PARK, Daejeon (KR); Sanghwan LEE, Seoul (KR); Jae-Il HAN, Seoul (KR)

Correspondence Address: CANTOR COLBURN, LLP, 20 Church Street, 22nd Floor, Hartford, CT, 06103, US

(73) Assignees: Electronics and Telecommunications Research Institute, Daejeon (KR); Kookmin University Industry Academy Cooperation Foundation, Seoul (KR)

(21) Appl. No.: 12/176,721

(22) Filed: Jul. 21, 2008

(30) Foreign Application Priority Data
Nov. 22, 2007 (KR) 10-2007-0119824

(51) Int. Cl. G06F 17/30; G06F 15/16

(52) U.S. Cl. 707/3; 709/217; 707/E17.014; 707/E17.032

(57) ABSTRACT

The present invention relates to a method of searching a metadata server that searches ubiquitous sensor network (USN) metadata servers in a distributed environment. The present invention stores location information on the metadata servers by using a location-server cluster and searches a location of a metadata server in which a specified resource metadata is stored, during a metadata searching request by a client. Accordingly, the present invention can provide a simple and consistent interface to the client using the metadata management servers in terms of the metadata servers and can improve the clarity of service development and can reduce the entire development costs and the maintenance and repair costs.

### CROSS-REFERENCE TO RELATED APPLICATION

This application claims priority to and the benefit of Korean Patent Application No. 10-2007-0119824 filed in the Korean Intellectual Property Office on Nov. 22, 2007, the entire contents of which are incorporated herein by reference.

### BACKGROUND OF THE INVENTION

(a) Field of the Invention

The present invention relates to a method of searching metadata servers. More particularly, the present invention relates to a method of searching ubiquitous sensor network (USN) metadata servers in a distributed environment.

The present invention was supported by the IT R&D program of MIC/IITA [2006-S-022-02, Development on USN Middleware Platform Technology].

(b) Description of the Related Art

An ubiquitous sensor network, or USN, means a network that provides humans with the most suitable function through automatic recognition of environment and circumstances by giving a sensing function, a computing function, and a network function to things including human living space, living appliances, and machines, so that a high degree of convenience and safety can be achieved in human living. USN permits automation in various fields. Through this technology, various services convenient to humans, including telematics, a home network, inventory control, patient management, animal management, natural disaster management, and an ITS system, can be provided.

A sensor network for implementing an ubiquitous environment means a network that generally consists of wireless sensor nodes and has a communication function. Generally, sensor nodes are densely distributed in the sensor network, and thereby failures of sensing and transmitting data can be corrected. In addition, the sensor network transmits data based on a communication according to a broadcast method. In addition, it is a characteristic of the sensor network to have a power, a memory, and an operating capability that are restricted by using a small sensor node that is wireless.

When a system is established using a sensor network, it is difficult to fully understand and use low technology. Therefore, USN middleware and middleware for sensor nodes have been developed, so that a sensor network-based system can be more easily established.

In this case, USN middleware filters, integrates, and analyzes sensing data collected from different types of sensor networks, so that USN middleware performs the function of extracting, storing, managing, and searching meaningful circumstance information, the function of transferring the information to an application service, or the function of connecting and integrating among services.

The middleware for sensor nodes is between a function of various application software for sensors and a function of an operating system and network. In addition, the middleware for sensor nodes supports all things that are necessary for maintenance, installation/distribution, and applied processing, and performs the function of adjusting programming in accordance with a program update and applied change of the sensor network with being embedded in a sensor node and a sync node. In addition, the middleware for sensor nodes performs the functions of database, storage and management of data, operation and processing of data suitable for various applications, and data fusion with respect to the sensing data measured at the sensor node and the sync node.

In general, when a USN-based system is established, a system that manages metadata of a sensor network is included inside the established system. A metadata management system that manages information of a kind of sensor network connected to a current system, a location of the sensor network, a function, a connecting method, an operating method, or the like, and information of sensor nodes included in the sensor network, a sensing type of each sensor node, sensing data, a location of each sensor, or the like, is established to make use of the information of the sensor network in the middleware or application program.

The metadata management system is constructed as a separate system or as a form of database in order that an associated system gets access to the metadata management system and performs the operation of registration, reference, or correction with respect to a required metadata.

However, the metadata management in this system is performed in one system in order to be suitable for being used with a small number of sensors in a narrow area. Accordingly, the metadata of the sensor network cannot be managed and provided in a network environment of broadband/distributed sensors having different types due to an installation of many sensors in a wide area.

### SUMMARY OF THE INVENTION

In order to solve the above problems, the technical object of the present invention is to provide a method of searching USN metadata servers in a distributed environment.

In addition, the object of the present invention is to search the location of a metadata management server that manages a metadata of a certain sensor in order to search the metadata of the certain sensor when large systems managing sensors and metadata of the sensor network exist in the distributed environment in a wide area where many sensors are present.

In order to achieve the above technical object of the present invention, information of a sensor and a sensor network that includes the sensor is necessary to use the sensor in a system using sensors or sensor networks. Accordingly, the present invention implements a method of searching a metadata management server that manages a certain metadata of a specified sensor network resource in a broadband and distributed environment where numerous metadata management servers manage metadata of each sensor network and where many sensors are distributed in a wide area.

An exemplary embodiment of the present invention is to provide a method of searching metadata servers in a distributed environment including: storing location information on the metadata servers by using a location-server cluster; and searching a location of a metadata server in which a specified resource metadata is stored, during a metadata searching request of a client.

Here, the location information may represent a pair of IDs of resources explained by the metadata and access information on a metadata management server in which the metadata is stored. Further, the location-server cluster may use one or a plurality of metadata location-servers.

In addition, the method of searching the metadata servers may further include forming and operating a metadata location-server group that is an assembly of servers capable of providing an address of a metadata server for managing the metadata by organically exchanging information among the metadata location-servers.

At this time, the forming and operating of the metadata location-server group may utilize a hierarchical structure. Alternatively, the forming and operating of the metadata location-server group may utilize an end-to-end structure. Moreover, the forming and operating of the metadata location-server group may utilize a combination of a hierarchical structure and an end-to-end structure.

In addition, the method of searching the metadata servers may further include: receiving a search request of a metadata server from the metadata server, in the metadata location-server; confirming whether or not a resource ID received from the metadata server is stored in a local area of the metadata location-server; and returning location information on a metadata server corresponding to the resource ID to the metadata server, when the resource ID locally exists in the local area.

Further, the method of searching the metadata servers may further include requesting a search of a metadata server corresponding to the resource ID while transmitting the resource ID to another metadata location-server, when the resource ID does not locally exist in the local area.

Another exemplary embodiment of the present invention is to provide a method of searching metadata servers in a distributed environment including: during a metadata searching and providing request of a client, confirming whether to manage a metadata corresponding to the request; when not managing the metadata, searching location information on a metadata server that manages the metadata by using a location-server; and after connecting to the metadata server by using the searched location information so as to deliver the request to the metadata server, receiving a response with regard to the request and transmitting the received response to the client.

The method of searching the metadata servers may further include: receiving a search request of metadata servers and resource IDs through the metadata server at a hierarchical metadata location-server group, in a local location-server; determining in the local location-server whether or not the resource ID belongs to a coverage interval of the local location-server; when the resource ID does not belong to the coverage interval of the local location-server, designating a parent location-server as a next location-registration server, in the local location-server; transmitting the resource ID to the next location-registration server while requesting a search of metadata servers, in the local location-server; determining in the next location-registration server whether or not the resource ID transmitted from the local location-server belongs to a coverage interval of the next location-registration server; determining in the next location-registration server whether or not the next location-registration server is a leaf location-registration server that stores ID-IP pair, when the transmitted resource ID belongs to the coverage interval of the next location-registration server; and returning an IP address of a metadata server for managing metadata on the resource ID to the local location-server, when the next location-registration server is the leaf location-registration server.

In addition, the method of searching the metadata servers may further include: finding a lower-layered location-registration server corresponding to the resource ID and returning an IP address of a root location-server thereof to the local location-server, when the next location-registration server is the leaf location-registration server; and transmitting the resource ID to a next location-registration server regarded as the IP address while requesting the search of metadata servers, in the local location-server.

Alternatively, the method of searching the metadata servers may further include: confirming whether or not a local location-server covers a resource ID in an end-to-end metadata location-server group; transmitting the resource ID to a next location-registration server regarded as the local location-server while requesting the search of metadata servers, in the local location-server, when the local location-server does not cover the resource ID; confirming in the next location-server whether to cover the resource ID received in the next location-server; finding a value corresponding to an interval in which the resource ID exists, in a finger table of the next location-server, when the next location-server does not cover the received resource ID; returning an IP address of a node corresponding to the value found by the next location-server to the local location-server, in the next location-server; and transmitting the resource ID to a next location-server regarded as the IP address that is received in the local location-server while requesting a search of metadata servers, in the local location-server.

Furthermore, the method of searching the metadata servers may further include returning an IP address of the next location-server to the local location-server, in the next location-server, when the next location-server covers the received resource ID.

Moreover, the method of searching the metadata servers may further include: when a new location-server is added to the location-server group, obtaining information on one location-server, which exists in the location-server group, in the new location-server; transmitting the ID of the new location-server to the obtained location-server and requesting a search of a metadata server that covers an interval including the ID, in the new location-server; confirming in the obtained location-server whether or not the obtained location-server covers the ID; finding a value corresponding to an interval in which the ID exists in a finger table of the obtained location-server, in the obtained location-server, when the obtained location-server does not cover the ID; returning an IP address of a node corresponding to the value found by the obtained location-server to the new location-server, in the obtained location-server; transmitting the ID to a next location-server regarded as the IP address that is received by the obtained location-server while requesting a search of metadata servers in the new location-server; confirming in the next location-server whether to cover the resource ID received in the next location-server; returning an IP address of the next location-server to the new location-server, in the next location-server, when the next location-server covers the received ID; requesting interval division to the next location-server, in the new location-server; by dividing an interval of the next location-server into halves, transferring one half to the new location-server and covering the other half, in the next location-server; providing information on all of finger tables of the next location-server to the new location-server and modifying a previous node pointer of the next location-server into the new location-server, in the next location-server; requesting to change a successive node pointer of this node into the new location-server by connecting with a previous node pointer of the next location-server, in the new location-server; regarding a previous node pointer of the new location-server as the previous node pointer of the next location-server and regarding a successive node pointer of the new location-server as the next location-server, in the new location-server; and modifying a finger table of the new location-server based on the information on the finger table, in the new location-server.

Here, the method of searching the metadata servers may further include: finding a newly entered node in the finger table corresponding to each server by periods and modifying the finger table. In addition, the method of searching the metadata servers may further include: modifying a finger table by finding newly entered nodes in the finger table corresponding to each server when an average visit frequency of a node is no less than a uniform value during searching. Furthermore, the method of searching the metadata servers may further include returning an IP address returned in the middle of every search and a coverage interval of a location-server of the IP address and modifying the finger table corresponding to each server based on the returned IP address and the coverage interval.

According to the present invention, it can provide simple and consistent interface to the client using the metadata management servers in terms of the metadata servers and can easily develops the USN system in the environment of a broadband sensor network over which developers and client programs are distributed. Ultimately, the present invention can improve the clarity of service development and can reduce the entire development costs and the maintenance and repair costs.

### BRIEF DESCRIPTION OF THE DRAWINGS

FIG. 1 is a flowchart illustrating a method of searching metadata servers according to an exemplary embodiment of the present invention.

FIG. 2 is a schematic diagram illustrating a hierarchical metadata location-server group according to an exemplary embodiment of the present invention.

FIG. 3 is a schematic diagram illustrating an example of the hierarchical metadata location-server group according to the exemplary embodiment of the present invention.

FIG. 4 is a schematic diagram illustrating an end-to-end metadata location-server group according to an exemplary embodiment of the present invention.

FIG. 5 is a schematic diagram illustrating a metadata location-server group formed by combining the hierarchical metadata location-server group and the end-to-end metadata location-server group according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification, unless explicitly described to the contrary, the word “comprise” and variations such as “comprises” and “comprising”, will be understood to imply the inclusion of stated elements but not the exclusion of any other elements. In addition, the terms “unit”, “-er” and “module” described in the specification mean units for processing at least one function and operation and can be implemented by hardware components or software components and combinations thereof.

A system using a lot of sensors should know not only sensing values read from the sensors but also metadata on sensors and sensor networks in order to read desired-information from a desired-sensor and control the sensor. Furthermore, several metadata management servers exist in a broadband sensor network and distributed environment that is not capable of managing all metadata in one metadata management server. In this case, it is essential to find which metadata management server manages a metadata corresponding to a specified sensor.

Accordingly, when numerous systems for managing metadata on sensors and sensor networks exist in the broadband distributed environment having many sensors, the present invention embodies a method of searching a location of a metadata management server for managing metadata of a corresponding sensor so as to search metadata of a specified sensor. At this time, the present invention is used so as to share sensor network metadata through an interlock between many sensor network metadata management servers.

The present invention finds an address of the metadata management server for managing metadata of a corresponding resource by receiving resource ID of a sensor network (for example, sensor network, sensor node, sensor, actuator, and sensing type). At this time, the present invention indicates three models (for example, centralized structure, tree structure, and end-to-end structure) and works by combining these models. Searching-target values exist in only a terminal node. Therefore, on the basis of the broadband sensor network in the distributed environment, the present invention may make it seem as if the metadata, which is not locally managed, is locally managed.

In addition, the present invention finds a metadata server for managing a specified metadata, when many metadata and numerous location-servers having location information on the metadata exist in the distributed environment. The present invention searches the server for managing the metadata by using a resource ID having a centralized structure, a hierarchical structure, an end-to-end structure, and a combined structure. For this reason, in the present invention, it looks as if all metadata are managed in the metadata management server to be used by a client.

In addition, the present invention finds which directory server is utilized. The present invention searches the metadata management server among several metadata management servers and finds the metadata management server when the metadata on the resources of the sensor network are managed by several systems in the distributed environment.

Furthermore, the present invention forms various types of distributed directory servers by using distributed lookup systems. According to the present invention, distributed metadata are searched by utilizing three kinds of lookup techniques.

A method of searching metadata servers according to an exemplary embodiment of the present invention will now be described in detail with reference to the drawings.

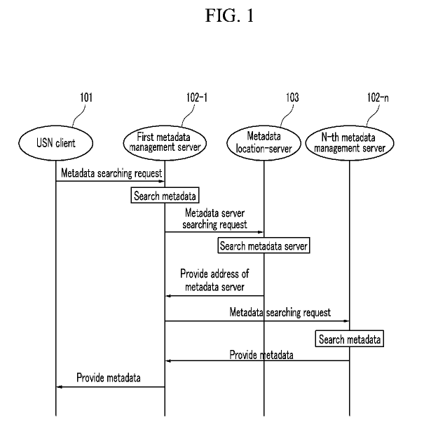

FIG. 1 is a flowchart illustrating a method of searching metadata servers according to an exemplary embodiment of the present invention.

Referring to FIG. 1, the method of searching the metadata servers according to the exemplary embodiment of the present invention will be briefly described.

In the method of searching the metadata servers in a distributed environment, the method stores location information on a USN metadata server by using a location-server cluster and searches the location of the USN metadata server in which the metadata of a specified resource is stored. Here, the location-server cluster includes one or a plurality of metadata location-servers 103.

That is, when a USN client 101 (i.e., terminal) for requiring metadata on sensors and sensor networks performs a metadata searching and providing request by being connected to a metadata management server 102-1 in the distributed environment, it confirms whether or not the metadata management server 102-1 manages metadata corresponding to the metadata searching and providing request of the USN client 101. At this time, when the metadata management server 102-1 does not manage the metadata corresponding to the metadata searching and providing request of the USN client 101, the metadata management server 102-1 is connected to a metadata location-server 103, thereby searching a location of a metadata management server 102-n that manages metadata corresponding to the metadata searching and providing request of the terminal 101. Here, the location information represents a pair of resource IDs explained by the metadata and access information on the metadata management server 102-n in which the metadata is stored.

Then, the metadata management server 102-1 is connected to the metadata management server 102-n by receiving searched results (that is, address information on the metadata management server 102-n) and transmits the metadata searching and providing request of the USN client 101. Moreover, the metadata management server 102-1 receives a response corresponding to the metadata searching and providing request of the USN client 101 to transmit the response corresponding to the metadata searching and providing request to the USN client 101.

Here, a metadata location-server group is formed and operated such that the metadata location-server 103 manages and searches the metadata management servers 102-1 and 102-n that manage the specified metadata. At this time, the metadata location-server group is formed and operated by using a hierarchical structure. Furthermore, in the hierarchical metadata location-server group, the metadata location-server group is formed and operated by using physical location information on the metadata management servers 102-1 and 102-n.

The metadata location-server group may be formed and operated by using an end-to-end structure.

Moreover, the metadata location-server group may be formed and operated by combining the hierarchical structure and the end-to-end structure.

Furthermore, the metadata location-server group may be formed and operated by combining the centralized structure, the hierarchical structure, and the end-to-end structure. That is, is a case of using a plurality of metadata location-servers 103, the metadata location-server group includes all of the centralized structure, the hierarchical structure, the end-to-end structure, and the combination thereof.

The method of searching the metadata servers according to the exemplary embodiment of the present invention will be described once more.

The client 101 for requesting the USN metadata is connected to the specified metadata management server 102-1 to request the metadata. When the metadata management server 102-1 does not directly manage the metadata corresponding to the metadata searching and providing request of the USN client 101, it receives the address of the metadata management server 102-n, which manages the corresponding metadata, by using the metadata location-server 10.

The metadata management server 102-1 is connected to the metadata management server 102-n by using this address information and transmits the request results by requesting the metadata received from the USN client 101.

For this reason, it is not necessary for the USN client 101 to perform finding of which metadata management server 102-1 and 102-n manages the required metadata, how to find the metadata management servers 102-1 and 102-n, and the operation for again requesting the same metadata to different metadata management servers 102-1 and 102-n.

Accordingly, the present invention can provide simple and consistent interface to the USN client 101 using the metadata management servers 102-1 and 102-n in terms of the metadata management servers 102-1 and 102-n. In addition, in the present invention, it looks as if the metadata management servers 102-1 and 102-n, which connect with the USN client 101, entirely manage the metadata of the sensors and sensor networks. Therefore, according to the present invention, a USN system is easily developed in the environment of a broadband sensor network over which developers and client programs are distributed. Ultimately, the present invention can improve the clarity of service development and can reduce the entire development costs and the maintenance and repair costs.

In a metadata search system using a USN metadata server searching system to which the present invention is applied, as shown in FIG. 1, the metadata search system includes the USN client 101, many metadata management servers 102-1 and 102-n, and the metadata location-server 103. Furthermore, the metadata search system according to the exemplary embodiment of the present invention further includes an inner system (for better comprehension and ease of description this is omitted in the drawings) of the USN system for requiring the USN metadata.

The USN client 101 can serve as a USN middleware or a USN application program. Moreover, the USN client 10 requests the search of metadata on the corresponding resource to the metadata management servers 102-1 and 102-n by using the resource ID of the sensor network and then receives the metadata from the metadata management servers 102-1 and 102-n.

The metadata management servers 102-1 and 102-n manage metadata on a specified sensor and sensor network and provide the corresponding metadata by receiving the metadata searching and providing request of the USN client 101. Here, the metadata management servers 102-1 and 102-n serve as a metadata management server for managing the metadata of the broadband sensor network in the distributed environment. Accordingly, since the metadata management servers 102-1 and 102-n manage only the metadata of the specified sensor network, several metadata management servers exist in the distributed environment. The metadata management servers 102-1 and 102-n provide a standardized interface capable of remotely requesting the search and provision of metadata.

The metadata location-server 103 manages a resource ID of the specified sensor network and an address of the metadata management servers 102-1 and 102-n, which manage the metadata of the corresponding resource, in pairs. Moreover, the metadata location-server 103 receives the resource ID of the sensor network from the metadata management servers 102-1 and 102-n and provides the address of the metadata management servers 102-1 and 102-n for managing the metadata of the corresponding resource. Here, the metadata location-server 103 manages the resource ID of the specified sensor network and the address of the metadata management servers 102-1 and 102-n in pairs. In order to manage the metadata management servers 102-1 and 102-n of the broadband sensor network in the distributed environment, one or several metadata location-servers 103 exist in the distributed environment. The metadata location-servers 103 organically exchange the information and form the metadata location-server group that is an assembly of servers capable of providing the address of the metadata management servers 102-1 and 102-n for managing the specified metadata.

At this time, the metadata location-server group may be formed by one of the centralized structure, the hierarchical structure, and the end-to-end structure, or may be formed by the combination thereof.

According to the centralized structure, there is one metadata location-server 103 that manages all of the resource IDs and the address of the metadata management servers 102-1 and 102-n corresponding thereto.

Several metadata location-servers 103 exist in the hierarchical metadata location-server group. Each of the metadata location-servers 103 is hierarchically formed based on the resource ID for management, and thereby the entire metadata location-server group is formed by one tree structure. Here, the hierarchical structure may be formed by dividing the resource ID into a bit unit, which is regarded as a continuous bit. In addition, the hierarchical structure may be formed by using the location information on the metadata management servers 102-1 and 102-n included in the resource ID.

An operation of the metadata search system using the USN metadata server searching system according to the exemplary embodiment of the present invention will now be described with reference to FIG. 1.

First, the USN client 101 requests the search of the metadata on the resource ID to a first metadata management server 102-1 by using the resource ID of the sensor network.

The first metadata management server 102-1 receives the metadata searching request from the USN client 101 and searches locally managed metadata. Then, the first metadata management server 102-1 confirms whether or not metadata corresponding to the metadata searching request of the USN client 101 exists. At this time, when the metadata exists, the first metadata management server 102-1 provides the metadata to the USN client 101 as a search result.

Meanwhile, when the metadata corresponding to the metadata searching request from the USN client 101 does not exist in the local area of the first metadata management server 102-1, the first metadata management server 102-1 requests to find the metadata management servers 102-2 to 102-n for managing the metadata on the corresponding resource by using the resource ID of the sensor network to the metadata location-server 103.

For this reason, the metadata location-server 103 receives the search request of the metadata management server from the first metadata management server 102-1 and confirms whether or not the resource ID received from the first metadata management server 102-1 is locally stored in the local area of the metadata location-server.

At this time, when the resource ID locally exists, the metadata location-server 103 returns the metadata server address corresponding to the ID to the first metadata management server 102-1.

However, when the resource ID does not locally exist, the metadata location-server 103 requests the search of the metadata management servers 102-2 to 102-n corresponding to the resource ID while transmitting the resource ID to another metadata location-server (for better comprehension and ease of description this is omitted in the drawings) of the metadata location-server group.

At this time, the metadata location-server 103 repeatedly transmits the resource ID to another metadata location-server so as to find the metadata management servers 102-2 to 102-n corresponding to the resource ID in the metadata location-server group. When the request arrives at the metadata location-server that manages the resource ID and the address of the metadata management servers 102-2 to 102-n corresponding to the resource ID, the address of the n-th metadata management server 102-n is returned to the first metadata management server 102-1, which requests first to the metadata location-server 103, through the metadata location-server, for example, in reverse order of the above-described repetitive request.

Then, the first metadata management server 102-1 is connected to the n-th metadata management server 102-n by using the returned address of the n-th metadata management server 102-n that manages the resource ID and requests the metadata search by using the resource ID.

Thus, the n-th metadata management server 102-n provides the metadata corresponding to the resource ID to the first metadata management server 102-1.

For this reason, the first metadata management server 102-1 provides the metadata received from the n-th metadata management server 102-n to the USN client 101.

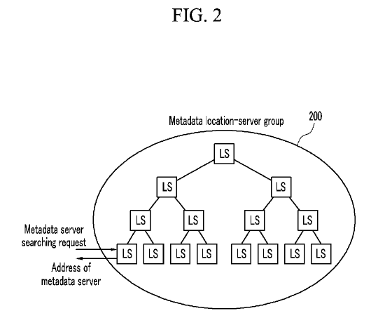

FIG. 2 is a schematic diagram illustrating a hierarchical metadata location-server group according to an exemplary embodiment of the present invention.

As shown in FIG. 2, a hierarchical metadata location-server group 200 according to the exemplary embodiment of the present invention considers the ID as a unique bit string. Therefore, the hierarchical metadata location-server group 200 maintains load balancing between location-registration servers (LS) by hierarchically dividing the range of the bit string.

In order to maintain the load balancing between location-registration servers (LS), a k-ary search tree is formed by using the location-registration server (LS). At this time, the height and degree of the search tree are determined by a processing power and an entire load of each location-registration server (LS).

When the location-registration server (LS) is considered as a node, each node stores an address of the parent node thereof. A root node is not necessary to store the parent node.

Each node stores a prefix of ID space covered by a sub-tree that is considered as a root and a length of the prefix. For example, when the ID space is ‘010xxxxxx’, the node stores ‘010’ and ‘3’.

In addition, each node stores a prefix of an ID space stored by root nodes thereof, a length of the prefix, and an IP address of the root nodes. At this time, the prefixes stored by the root nodes may not be the same. For example, a prefix of the node is ‘010xxxx’, but prefixes of three root nodes may be ‘0100xxx’, ‘01010xx’, and ‘01011xx’, respectively.

The sum of all the prefixes in the root nodes should be the same as the prefix of the node. That is, an empty space should not exist. For example, even though the prefix of the node is ‘010xxxx’, when the prefixes of two root nodes are ‘0100xxx’ and ‘01011 xx’, respectively, an empty space exists. A leaf node stores a real ID-IP pair corresponding to the ID space stored by itself instead of the root node.

In the hierarchical metadata location-server group 200, the number of location-registration servers (LS) is first determined, and then the location-registration servers (LS) are formed based on the above-described tree structure by a location-server administrator.

Here, each metadata management server defines one of the leaf location-registration servers in the metadata location-server group 200 as a local location-server of its own.

All of the location-registration servers are not necessary to be performed in independent equipment, and one integrated location-server may store the information stored by several location-registration servers. For example, three location-registration servers of the left sub-tree shown in FIG. 2 may be stored together in one location-registration server.

An operation of the hierarchical metadata location-server group 200 is the same as in a DNS lookup. First, when the metadata management server receives the request from a user, which searches the metadata by using the resource ID, the metadata management server is connected to the local location-server of its own to inform the local location-server of the resource ID.

Thus, the metadata management server executes a repetitive search on the basis of the local location-server. That is, the local location-server determines whether the informed resource ID belongs to a coverage interval thereof. Then, when the ID belongs to the coverage interval, the local location-server returns the IP corresponding to the ID to the metadata management server.

Meanwhile, when the ID does not belong to the coverage interval, the local location-server designates a parent location-server of its own as a next location-registration server. In addition, the local location-server transmits the ID to the next location-registration server.

For this reason, the next location-registration server receiving the ID transmitted from the local location-server determines whether the requested ID belongs to an ID interval thereof. At this time, when the requested ID does not belong to the ID interval of its own, the next location-registration server returns the IP of the parent location-server of its own to the local location-server. Here, the IP becomes a next location-registration server.

Furthermore, when the ID belongs to its own interval, the next location-registration server determines whether to be the leaf location-registration server that stores the ID-IP pair. At this time, when being the leaf location-registration server that stores the ID-IP pair, the next location-registration server returns the IP corresponding to the ID, that is, the IP of the metadata management server that manages the metadata on the resource ID to the local location-server.

Then, the local location-server returns the IP to the metadata management server that first requests the metadata search. Thus, the process of finding the metadata management server is completed.

Meanwhile, even though the ID belongs to its own interval, when not being the leaf location-registration server, the next location-registration server finds a low-layered location-registration server corresponding to the ID and returns the IP of a root location-server thereof to the local location-server. Here, the IP becomes a next location-registration server. Then, as described above, it repeats the process of finding the metadata management server since the ID is transmitted to the next location-registration server.

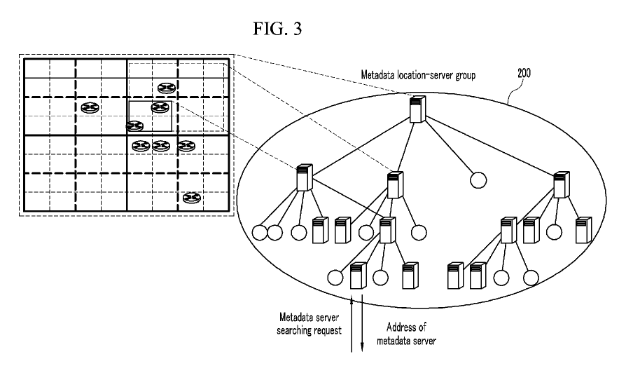

FIG. 3 is a schematic diagram illustrating an example of a hierarchical metadata location-server group using location information on the metadata management server according to the exemplary embodiment of the present invention.

In a hierarchical metadata location-server group 300 using the location information on the metadata management server according to the exemplary embodiment of the present invention, as shown in FIG. 3, when the hierarchical structure is formed by using a geographical location of the metadata management server, it is possible to optimize a response time with respect to a message request.

First, assuming that an entire interval is a ‘quadrangle’, it divides the interval into four equal parts. Each of the divided intervals is divided once again into four equal parts. The above-described division is repeated until the hierarchical structure having a desired height is formed.

FIG. 3 illustrates an example divided into an interval where the height is ‘3’. An existence interval of the metadata management server is marked on each interval. Each location-server is disposed on each interval. A server covering an upper interval becomes a parent node of four servers that cover a lower interval. Servers corresponding to a leaf node store the real ID-IP pair.

FIG. 3 illustrates the hierarchical structure between these location-servers. Actually, it is not necessary that the location-server exists in the interval where the metadata management server does not exist.

This can obtain more rapidly information on a linked sensor network or a sensor node, since information on nodes geologically close to each other is stored in the same leaf node. When this structure is formed, the number of necessary location-servers increases. Accordingly, there is no actual burden to execute the location-server in each metadata management server.

In the hierarchical metadata location-server group 300 using the location information on each metadata management server, each node has the following information.

Each metadata management server stores the location information of itself. As in the case of the sensor network, it is represented as 42-bit. The 42-bit is separated into longitude of 21-bit and latitude of 21-bit. By combining each first bit of the longitude and latitude, an entire interval is separated into four parts. That is, the entire interval is separated into ‘0-0-’, ‘0-1-’, ‘1-0-’, and ‘1-1-’.

Each interval is separated once again into four parts, and this procedure is repeated. Each node stores an address of a parent node thereof. The root node is not necessary to store the parent node.

Each node remembers the interval covered by a sub-tree that is considered as a root. Each node stores an interval covered by the root nodes of its own and an IP address of the root node.

A sum of all intervals of the root node should be the same as the interval of its own. The root interval, which does not have the metadata management server, is not necessary to place the location-server. The leaf node stores a real ID-IP pair corresponding to the ID interval stored by oneself instead of the root node.

In the hierarchical metadata location-server group 300 using the location information on the metadata management server, the operation for searching the metadata management server is the same as in the hierarchical metadata location-server group formed by classifying the ID in a bit unit without using the location information.

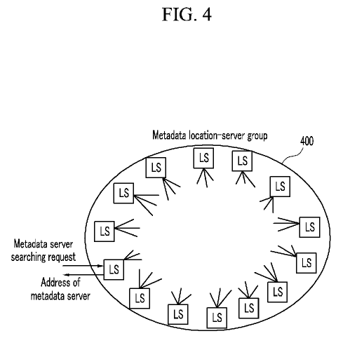

FIG. 4 is a schematic diagram illustrating an end-to-end metadata location-server group according to an exemplary embodiment of the present invention.

In the end-to-end metadata location-server group 400 according to the exemplary embodiment of the present invention, as shown in FIG. 4, each metadata management server simultaneously carries out the role of the location-server (LS).

Naturally, the role of the LS is not carried out in the inside of the metadata management server, but the LS role is carried out by one in a machine in which the metadata management server is executed. Various P2P systems are presented. However, since performance (for example, message number) up to query process is mostly similar to one another, P2P configuration is formed based on a chord system, which is the most typical P2P system, in the present invention. In the chord system, ID equally operates both in a case of storing information on the metadata management server and in a case of not storing the information.

In the end-to-end metadata location-server group 400, each node stores the following information.

Each location-server (LS) has a unique ID. In brief, there is ID of one sensor network covered by this metadata management server. The ID is regarded as one point on a circle by modulo operation. By the above-described definition, each location-server is equivalent to one point of the circle.

In addition, each location-server has an ID interval of its own. Each location-server stores the interval covered by the corresponding node on this circle. Basically, each location-server includes its own ID and covers an interval followed by the ID interval of a just before node.

Furthermore, each location-server has an ID-IP pair and stores the ID-IP pair that belongs to the ID interval covered by itself. In addition, each location-server stores an IP address and ID of the next node to itself, which is a successive node pointer (succ).

Finally, each location-server stores an IP address and ID of a just before node to itself, which is a previous node pointer (pred).

When the above-described contents are in existence, all of the nodes configure a circular topology on the basis of the successive node pointer and the previous node pointer. If the resource ID of the sensor network is given, it is possible to find the location-server that stores the corresponding ID-IP pair based on the successive node pointer and the previous node pointer.

However, if worse comes to worst, there is the possibility that all of the nodes are visited (i.e., all the location-servers). However, this is not the aim of the present invention. Accordingly, a finger table for managing pointer information on the LS in the form of a table is further stored in order to raise the search speed.

The finger table is configured as follows. If the number of total nodes is ‘n’, and the ID thereof is expressed as ‘x’ in one node, this node stores the following node pointer.

First, since a length of the ID is fixed to ‘128’, the node has 128 pointers. Nodes included in these pointers are as follows. That is, the nodes are an IP address and ID that have an interval including ID ‘x+1’, an IP address and ID that have an interval including ID ‘x+2’, an IP address and ID that have an interval including ID ‘x+4’, and an IP address and ID that have an interval including ID ‘x+2^{k}’. At this time, the value of k is from ‘0’ to ‘127’.

A method of searching in the end-to-end metadata location-server group 400 is to find from one local location-server to the location-server covering a specified ID. The method is as follows.

First, the local location-server confirms whether to cover this ID. At this time, when the local location-server covers the ID, the search is completed.

However, when the local location-server does not cover the ID, it regards itself as a next location-server in advance.

Then, the search is requested by transmitting the ID to the next location-server. Thus, the next location-server confirms whether this ID belongs to the coverage interval thereof. At this time, when the ID belongs to the coverage interval thereof, the next location-server returns its own IP to the local location-server, thereby completing the search.

Meanwhile, when the next location-server does not cover the corresponding ID, it finds the value of ‘k’ corresponding to the interval in which the corresponding ID exists, in the finger table of its own. That is, the next location-server finds the value of ‘k’ which belongs to the ID of (x+2k−1, x+2k). An IP address of the node corresponding to the value of ‘k’ is returned to the local location-server.

Hence, the local location-server repeats once again the operation for requesting the search by regarding the returned IP address as a next location-server and transmitting the ID to the next location-server.

Meanwhile, in the end-to-end metadata location-server group 400, when a new node is added, it should newly configure all information to be stored by this node. In addition, it should also modify information stored by some nodes. These operations are as follows.

The new location-server ‘N’ obtains information on one location-server ‘E’, which exists in an existing P2P location-server group 400, from the administrator.

Moreover, the new location-server ‘N’ transmits its own ID to the location-server ‘E’ and requests to find a node that covers an interval including this ID.

Thus, the location-server ‘E’ finds an IP of location-server ‘T’ that covers the interval including the ID of the new location-server ‘N’ through the search process in the above-described end-to-end metadata location-server group 400 and returns it to the new location-server ‘N’.

That is, the location-server ‘E’ confirms whether to cover the ID received from the new location-server ‘N’. At this time, when the location-server ‘E’ does not cover the ID of the new location-server ‘N’, it finds the value of ‘k’ corresponding to the interval in which the ID of the new location-server ‘N’ exists, in the finger table of its own. Furthermore, the location-server ‘E’ returns an IP address of the location-server ‘T’ corresponding to the value of ‘k’ to the new location-server ‘N’.

Hence, the new location-server ‘N’ requests the search by regarding the IP address received from the location-server ‘E’ as a next location-server and transmitting its own ID to the next location-server (that is, location-server ‘T’). Thus, the location-server ‘T’ confirms whether to cover the ID received from the new location-server ‘N’. When the location-server ‘T’ covers the received ID, it returns the IP address of its own to the new location-server ‘N’.

Accordingly, the new location-server ‘N’ requests the interval division to the location-server ‘T’.

Then, by dividing its own interval into halves, the location-server ‘T’ transfers the front half to the new location-server ‘N’ and covers the back half of its own. At this time, the location-server ‘T’ provides information on all the finger tables of its own to the new location-server ‘N’. In addition, the location-server ‘T’ modifies the previous node pointer or its own into the new location-server ‘N’.

Furthermore, the new location-server ‘N’ is connected to the previous node pointer of the location-server ‘T’ and requests to change the successive node pointer of this node into the new location-server ‘N’. In addition, the previous node pointer of the new location-server ‘N’ is regarded as a previous node pointer of the location-server ‘T’, and the successive node pointer thereof is regarded as a location-server ‘T’.

Moreover, the new location-server ‘N’ modifies the finger table of its own based on the finger table information provided from the location-server ‘T’. In order to modify the finger table, as described above, an inquiry of the search process is repeated by each values of ‘k’ at the end-to-end metadata location-server group 400. Actually, all values of ‘k’ are not necessary to perform the inquiry operation.

In addition, if the previous node pointer and the successive node pointer are actually stored, even though the information on the finger table is somewhat incorrect, there is no difficulty in searching. However, a stabilization process is performed for the shake of correct information.

The stabilization process is performed by following three types. First, the stabilization process finds newly entered nodes of the finger table of itself and modifies the entry nodes by periods. Second, instead of the periodic performance, the stabilization process may be performed when an average visit frequency of a node is no less than a uniform value during the search. Third, the stabilization process allows the IP address and the coverage interval of the location-server to be returned in the middle of the search and modifies the finger table of its own based on the returned IP address and coverage interval.

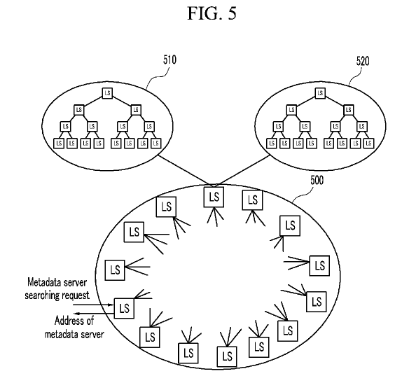

Hereinafter, a structure of a metadata location-server group formed by a combination of end-to-end structure and hierarchical structure will be described with reference to FIG. 5.

FIG. 5 is a schematic diagram illustrating a metadata location-server group formed by a combination of end-to-end structure and hierarchical structure according to an exemplary embodiment of the present invention.

As shown in FIG. 5, in the metadata location-server group 500 formed by the combination of end-to-end structure and hierarchical structure according to the exemplary embodiment of the present invention, entire metadata management servers are divided into several groups 510 and 520.

The metadata management servers in each group 510 and 520 are formed by one hierarchical structure. The end-to-end structure is formed by gathering root nodes of the corresponding hierarchical structure. The root nodes simultaneously perform the root role of the hierarchical structure and the node role of the end-to-end structure.

An operation for searching the metadata location-server group 500 formed by the combination of the end-to-end structure and the hierarchical structure is the same as in the hierarchical metadata location-server group. If patterns are matched with each other in the root node, the search is performed in another hierarchical metadata location-server group by using the end-to-end structure.

As described above, according to the exemplary embodiment of the present invention, when many systems for managing the metadata of the sensor and the sensor network are present in the distributed environment, in order to search the metadata of a specified sensor, the method of searching the location of the metadata management server for managing the metadata of the specified sensor is described.

At this time, according to the exemplary embodiment of the present invention, the client (that is, terminal) for requesting the USN metadata is connected to the specified metadata management server and requests the metadata. When the metadata management server does not directly manage the corresponding metadata, the metadata management server receives the address of the metadata management server, which manages the corresponding metadata, by using the metadata location-server, connects to the metadata management server by using this address information, and transmits the request results to the client by requesting the metadata received from the client. For this reason, it is not necessary for the client to perform finding which metadata management servers manage the required metadata, how to find the metadata management servers, and the operation for again requesting the same metadata to different metadata management servers. As a result, the present invention can provide a simple and consistent interface to the client using the metadata management servers in terms of the metadata servers. In addition, in the present invention, it looks as if the metadata management servers, which connect with the client, entirely manage the metadata of sensors and sensor networks. Therefore, according to the present invention, the USN system is easily developed in the environment of a broadband sensor network over which developers and client programs are distributed. Ultimately, the present invention can improve the clarity of service development and can reduce the entire development costs and the maintenance and repair costs.

The exemplary embodiment of the present invention can not only be implemented by the above-described apparatus and/or method, but can alternatively be implemented by, for example, a program that achieves the functions corresponding to the structure of the exemplary embodiment of the present invention and a recording medium (for example, CD-ROMs, RAM, ROM, floppy disks, hard disks, optical-magnetic disks) in which the program is recorded. This will be easily implemented from the above-described exemplary embodiment of the present invention by those skilled in the related art.

Although exemplary embodiments of the present invention have been described in detail, the scope of the present invention is not limited hereto. Various changes and modifications using the principle of the present invention as defined in the appended claims are also included in the scope of the present invention.

What is claimed is:

1. A method of searching metadata servers in a distributed environment, comprising:
storing location information on the metadata servers by using a location-server cluster; and
searching a location of a metadata server in which a specified resource metadata is stored, when a metadata searching of a client is requested.

2. The method of claim 1, wherein the location information represents a pair of IDs of resources explained by the metadata and access information on a metadata management server in which the metadata is stored.

3. The method of claim 1, wherein the location-server cluster uses one or a plurality of metadata location-servers.

4. The method of claim 3, further comprising:
forming and operating a metadata location-server group that is an assembly of servers capable of providing an address of a metadata server for managing the metadata by exchanging information among the metadata location-servers.

5. The method of claim 4, wherein the forming and operating of the metadata location-server group utilizes a hierarchical structure.

6. The method of claim 4, wherein the forming and operating of the metadata location-server group utilizes an end-to-end structure.

7. The method of claim 4, wherein the forming and operating of the metadata location-server group utilizes a combination of a hierarchical structure and an end-to-end structure.

8. The method of claim 4, further comprising:
receiving a search request of a metadata server from the metadata server, in the metadata location-server;
confirming whether or not resource ID received from the metadata server is locally stored in a local area of the metadata location-server; and
returning location information on a metadata server corresponding to the resource ID to the metadata server, when the resource ID locally exists in the local area.

9. The method of claim 8, further comprising:
requesting a search of a metadata server corresponding to the resource ID while transmitting the resource ID to another metadata location-server, when the resource ID does not locally exist in the local area.

10. A method of searching metadata servers in a distributed environment, comprising:
during a metadata searching and providing request of a client, confirming whether to manage a metadata corresponding to the request;
when not managing the metadata, searching location information on a metadata server, which manages the metadata, by using a location-server; and
after connecting to the metadata server by using the searched location information so as to deliver the request to the metadata server, receiving a response with regard to the request and transmitting the received response to the client.

11. The method of claim 10, further comprising:
receiving a search request of a metadata server and resource ID through the metadata server in a local location-server of a hierarchical metadata location-server group;
determining in the local location-server whether or not the resource ID belongs to a coverage interval of the local location-server;
when the resource ID does not belong to the coverage interval of the local location-server, designating a parent location-server as a next location-registration server, in the local location-server;
transmitting the resource ID to the next location-registration server while requesting a search of metadata server, in the local location-server;
determining in the next location-registration server whether or not the resource ID transmitted from the local location-server belongs to a coverage interval of the next location-registration server;
determining in the next location-registration server whether or not the next location-registration server is a leaf location-registration server that stores an ID-IP pair, when the transmitted resource ID belongs to the coverage interval of the next location-registration server; and
returning an IP address of a metadata server for managing metadata on the resource ID to the local location-server, when the next location-registration server is the leaf location-registration server.

12. The method of claim 11, further comprising:
finding a lower-layered location-registration server corresponding to the resource ID and returning an IP address of a root location-server thereof to the local location-server, when the next location-registration server is the leaf location-registration server; and
transmitting the resource ID to a next location-registration server regarded as the IP address while requesting the search of metadata servers, in the local location-server.

13. The method of claim 10, further comprising:
confirming whether or not a local location-server covers the resource ID in an end-to-end metadata location-server group;
transmitting the resource ID to a next location-registration server regarded as the local location-server while requesting the search of metadata servers, in the local location-server, when the local location-server does not cover the resource ID;
confirming in the next location-server whether to cover the resource ID received in the next location-server;
finding a value corresponding to an interval in which the resource ID exists, in a finger table of the next location-server, when the next location-server does not cover the received resource ID;
returning an IP address of a node corresponding to the value found by the next location-server to the local location-server, in the next location-server; and
transmitting the resource ID to a next location-server regarded as the IP address that is received in the local location-server while requesting a search of metadata servers, in the local location-server.

14. The method of claim 13, further comprising:
returning an IP address of the next location-server to the local location-server, in the next location-server, when the next location-server covers the received resource ID.

15. The method of claim 13, further comprising:
when a new location-server is added to the location-server group, obtaining information on one location-server, which exists in the location-server group, in the new location-server;
transmitting the ID of the new location-server to the obtained location-server and requesting a search of a metadata server that covers an interval including the ID, in the new location-server;
confirming in the obtained location-server whether or not the obtained location-server covers the ID;
finding a value corresponding to an interval in which the ID exists in a finger table of the obtained location-server, in the obtained location-server, when the obtained location-server does not cover the ID;
returning an IP address of a node corresponding to the value found by the obtained location-server to the new location-server, in the obtained location-server;
transmitting the ID to a next location-server regarded as the IP address that is received by the obtained location-server while requesting a search of metadata servers in the new location-server;
confirming in the next location-server whether to cover the resource ID received in the next location-server;
returning an IP address of the next location-server to the new location-server, in the next location-server, when the next location-server covers the received ID;
requesting interval division to the next location-server, in the new location-server;
by dividing an interval of the next location-server into halves, transferring one half to the new location-server and covering the other half, in the next location-server;
providing information on all the finger tables of the next location-server to the new location-server and modifying a previous node pointer of the next location-server into the new location-server, in the next location-server;
requesting to change a successive node pointer of this node into the new location-server by connecting with a previous node pointer of the next location-server, in the new location-server;
regarding a previous node pointer of the new location-server as the previous node pointer of the next location-server and regarding a successive node pointer of the new location-server as the next location-server, in the new location-server; and
modifying a finger table of the new location-server based on the information on the finger table, in the new location-server.

16. The method of claim 15, further comprising:
finding newly entered nodes of the finger table corresponding to each server by periods and modifying the finger table.

17. The method of claim 15, further comprising:
modifying a finger table by finding newly entered nodes of the finger table corresponding to each server when an average visit frequency of a node is no less than a uniform value during searching.

18. The method of claim 15, further comprising:
returning an IP address returned in the middle of every search and a coverage interval of a location-server of the IP address and modifying the finger table corresponding to each server based on the returned IP address and the coverage interval.
